(19) United States
(12) Patent Application Publication
(10) Pub. No.: US 2026/0081150 A1
(43) Pub. Date: Mar. 19, 2026

(54) NONAQUEOUS ELECTROLYTE BATTERY AND BATTERY PACK

(71) Applicant: KABUSHIKI KAISHA TOSHIBA, Kawasaki-shi (JP)

(72) Inventors: Naoki NISHIO, Yokohama Kanagawa (JP); Toshitada NAKAZAWA, Yokohama Kanagawa (JP)

(73) Assignee: KABUSHIKI KAISHA TOSHIBA, Kawasaki-shi (JP)

(21) Appl. No.: 19/401,785

(22) Filed: Nov. 26, 2025

Related U.S. Application Data
(63) Continuation of application No. PCT/JP2024/010594, filed on Mar. 18, 2024.

(51) Int. Cl. H01M 4/525; H01M 4/485; H01M 10/0525

(52) U.S. Cl. CPC H01M 4/525; H01M 4/485; H01M 10/0525

(57) ABSTRACT

According to one embodiment, provided is a nonaqueous electrolyte battery including a positive electrode containing a lithium-containing nickel-cobalt-manganese oxide, a negative electrode containing a lithium titanium-containing oxide, and a nonaqueous electrolyte. A ratio P^{Li—F}/P^{Ni} of a peak intensity P^{Li—F} of a highest intensity peak within 682 eV to 685 eV to a peak intensity P^{Ni} of a highest intensity peak within 850 eV to 858 eV in an X-Ray photoelectron spectrum of a positive electrode surface is 0.6 or more and 1 or less. A ratio N^{Li—F}/N^{Ti} of a peak intensity N^{Li—F} of a highest intensity peak within 682 eV to 685 eV to a peak intensity N^{Ti} of a highest intensity peak within 454 eV to 460 eV in an X-Ray photoelectron spectrum of a negative electrode surface is 1.8 or more and 3 or less.

### CROSS-REFERENCE TO RELATED APPLICATION

This application is a Continuation Application of PCT Application No. PCT/JP2024/010594, filed Mar. 18, 2024, the entire contents of which are incorporated herein by reference.

### FIELD

Embodiments described herein relate generally to a nonaqueous electrolyte battery and battery pack.

### BACKGROUND

Secondary batteries, including lithium ion secondary batteries, have been widely used in portable devices, vehicles such as automobiles, storage batteries, and the like. The secondary battery is a power storage device that is expected to expand in market scale.

The secondary battery includes electrodes, including a positive electrode and a negative electrode. The secondary battery may further include an electrolyte. In a secondary battery having a certain design, an electrode includes a current collector and an active material-containing layer provided on a principal surface (s) of the current collector. The active material-containing layer of the electrode may be, for example, a layer formed of active material particles, an electro-conductive agent, and a binder, and may be a porous body capable of holding an electrolyte.

Lithium titanate is an example of an active material used for a negative electrode of a lithium ion battery or a secondary battery. A lithium ion secondary battery using lithium titanate for a negative electrode is excellent in low-temperature input and output and life performance.

### BRIEF DESCRIPTION OF THE DRAWINGS

FIG. 1 is a partially cutaway perspective view illustrating an example of a battery according to an embodiment.

FIG. 2 is an enlarged sectional view of a section A of the battery illustrated in FIG. 1.

FIG. 3 is a partially cutaway perspective view illustrating another example of the battery according to the embodiment.

FIG. 4 is a partially cutaway perspective view illustrating another example of the battery according to the embodiment.

FIG. 5 is an enlarged sectional view of a section B of the battery illustrated in FIG. 4.

FIG. 6 is an exploded perspective view schematically illustrating an example of the battery pack according to an embodiment.

FIG. 7 is a block diagram illustrating an example of an electric circuit of the battery pack illustrated in FIG. 6.

### DETAILED DESCRIPTION

According to one embodiment, provided is a nonaqueous electrolyte battery including a positive electrode containing a lithium-containing nickel-cobalt-manganese oxide, a negative electrode containing a lithium titanium-containing oxide, and a nonaqueous electrolyte. A ratio P^{Li—F}/P^{Ni} of a peak intensity P^{Li—F} of a highest intensity peak appearing within a range of 682 eV to 685 eV in an X-Ray photoelectron spectrum of a positive electrode surface of the positive electrode to a peak intensity P^{Ni} of a highest intensity peak appearing within a range of 850 eV to 858 eV in the X-Ray photoelectron spectrum of the positive electrode surface is 0.6 or more and 1 or less. A ratio N^{Li—F}/N^{Ti} of a peak intensity N^{Li—F} of a highest intensity peak appearing within a range of 682 eV to 685 eV in an X-Ray photoelectron spectrum of a negative electrode surface of the negative electrode to a peak intensity N^{Ti} of a highest intensity peak appearing within a range of 454 eV to 460 eV in the X-Ray photoelectron spectrum of the negative electrode surface is 1.8 or more and 3 or less.

According to another embodiment, provided is a battery pack including the nonaqueous electrolyte battery according to the above embodiment.

A lithium ion secondary battery using lithium titanate for a negative electrode is excellent in low-temperature input-and-output and life performance. On the other hand, such a battery has a problem in that the amount of gas generated is large.

As a countermeasure against gas generation, covering of lithium titanate with a polymeric material or the like has been considered. However, such a cover layer has low Li ion conductivity and thus becomes as a resistance component. Consequently, the characteristics of lithium titanate cannot be fully utilized.

As another means, active materials having a layered structure may be added. Among such active materials, a lithium-containing cobalt oxide plays a role of a gas adsorbent. Therefore, by using a lithium-containing cobalt oxide as a positive electrode active material, gas generation is reduced. However, a lithium-containing cobalt oxide has a problem in that there is a large deterioration at a high potential. Thus, as an alternative to the lithium-containing cobalt oxide, use of a lithium-containing nickel-cobalt-manganese oxide has been studied.

Hereinafter, embodiments will be described with reference to the drawings. Note, that same reference numerals are given to the same components throughout the embodiments, and redundant description will be omitted. Each drawing is a schematic view for promoting the explanation and understanding thereof, and shapes, dimensions, ratios, and the like thereof are different from those of an actual apparatus, and these can be appropriately designed and changed, in consideration of the following description and known techniques.

### First Embodiment

According to a first embodiment, a nonaqueous electrolyte battery including a positive electrode, a negative electrode, and a nonaqueous electrolyte is provided. The positive electrode contains a lithium-containing nickel-cobalt-manganese oxide as a first active material. In a spectrum obtained by analyzing the positive electrode surface by X-Ray photoelectron spectroscopy (XPS), a ratio p^{Li—F}/p^{Ni}, of a peak intensity P^{Li—F} of a highest intensity peak appearing within a range of 682 eV to 685 eV to a peak intensity P^{Ni} of a highest intensity peak appearing within a range of 850 eV to 858 eV, is 0.6 or more and 1 or less. The negative electrode contains a lithium titanium-containing oxide. In a spectrum obtained by analyzing the negative electrode surface by XPS, a ratio N^{Li—F}/N^{Ti}, of a peak intensity N^{Li—F} of a highest intensity peak appearing within a range of 682 eV to 685 eV to a peak intensity N^{Ti} of a highest intensity peak appearing within a range of 454 eV to 460 eV, is 1.8 or more and 3 or less.

In the XPS spectrum obtained by analysis of the positive electrode surface by XPS, the highest intensity peak appearing in the range of 682 eV to 685 eV is attributed to Li—F bonds among F1s components derived from fluorine present on the positive electrode surface. In the same spectrum, the highest intensity peak appearing in the range of 850 eV to 858 eV is attributed to Ni2p3 components derived from nickel present on the positive electrode surface.

In the XPS spectrum obtained by analysis of the negative electrode surface by XPS, the highest intensity peak appearing in the range of 682 eV to 685 eV is attributed to Li—F bonds among F1s components derived from fluorine present on the negative electrode surface. In the same spectrum, the highest intensity peak appearing in the range of 454 eV to 460 eV is attributed to Ti2P3 components derived from titanium present on the negative electrode surface.

Each of the positive electrode and the negative electrode included in the nonaqueous electrolyte battery has a fluorine-containing coating-film on the electrode surface. The positive electrode includes, for example, a positive electrode active material-containing layer containing a lithium-containing nickel-cobalt-manganese oxide as a positive electrode active material, and the positive electrode active material-containing layer may be covered with the fluorine-containing coating-film. Similarly, the negative electrode may include, for example, a negative electrode active material-containing layer containing a lithium titanium-containing oxide as a negative electrode active material, and the negative electrode active material-containing layer may be covered with the fluorine-containing coating-film. In both the positive electrode and the negative electrode, gas is generated by a decomposition reaction of the nonaqueous electrolyte. The fluorine-containing coating-film suppresses the decomposition reaction of the nonaqueous electrolyte on each of the positive electrode surface and the negative electrode surface, thereby reducing gas generation at each electrode. While a side reaction leading to gas generation can be suppressed, the fluorine-containing coating-film has a Li ion conductivity. Therefore, there is a small change in internal resistance caused by providing the coating-film, and the input/output performance of the battery is not significantly impaired. Each fluorine-containing coating-film may contain, for example, lithium fluoride.

In the XPS spectrum for the positive electrode surface, the peak intensity P^{Li—F} of the highest intensity peak within the range of 682 eV to 685 eV represents the proportion of the fluorine-containing coating-film covering the surface of the positive electrode active material-containing layer (hereinafter also referred to as a positive electrode coating-film). In the same spectrum, the peak intensity P^{Ni} of the highest intensity peak within the range of 850 eV to 858 eV represents the proportion of the lithium-containing nickel-cobalt-manganese oxide that the positive electrode contains as an active material on the positive electrode surface. Therefore, the ratio P^{Li—F}/P^{Ni} of the former to the latter indicates the degree of coverage by the positive electrode coating-film. Similarly, in the XPS spectrum for the negative electrode surface, the peak intensity N^{Li—F} of the highest intensity peak within the range of 682 eV to 685 eV represents the proportion of the fluorine-containing coating-film covering the surface of the negative electrode active material-containing layer (hereinafter also referred to as a negative electrode coating-film), and the peak intensity N^{Ti} of the highest intensity peak within the range of 454 eV to 460 eV represents the proportion of the lithium titanium-containing oxide that the negative electrode contains as an active material on the negative electrode surface. Therefore, the ratio N^{Li—F}/N^{Ti} of the former to the latter indicates the degree of coverage by the negative electrode coating-film.

In the nonaqueous electrolyte battery, the ratio P^{Li—F}/P^{Ni} in the XPS spectrum of the positive electrode surface is 0.6 to 1, and the ratio N^{Li—F}/N^{Ti} in the XPS spectrum of the negative electrode surface is 1.8 to 3. That is, the degree of covering of the negative electrode with the negative electrode coating-film is larger than the degree of covering of the positive electrode with the positive electrode coating-film.

As described above, gas is generated by the side reaction between the positive electrode active material and the nonaqueous electrolyte and the side reaction between the negative electrode active material and the nonaqueous electrolyte. The gas generated at the negative electrode contains carbon monoxide (CO) gas generated by the reduction reaction of the nonaqueous electrolyte. The CO generated at the negative electrode is oxidized at the positive electrode to become carbon dioxide (CO₂), which can be dissolved into the nonaqueous electrolyte. In a nonaqueous electrolyte battery in which the ratio of the coating-film components on the positive electrode and the negative electrode are as described above, gas generation at the negative electrode is suppressed by the covering of the negative electrode, and at the same time, the positive electrode can exhibit the CO oxidation ability by keeping the covering of the positive electrode relatively small. The nonaqueous electrolyte battery thus has a good balance of gas generation between the positive and negative electrodes.

The ratio P^{Ni}/N^{Ti} of the peak intensity P^{Ni} to the peak intensity N^{Ti} is preferably 1.2 to 1.5. Each of these peak intensities p^{Ni} and N^{Ti} represents the proportion of the surface of the active material-containing layer that is not covered with the fluorine-containing coating-film and may be in direct contact with the nonaqueous electrolyte. In a battery in which the ratio P^{Ni}/N^{Ti} is within the above range, the reductive reaction at the negative electrode that generates CO and the oxidation reaction at the positive electrode that converts CO into CO₂ are balanced.

The amount of the negative electrode coating-film present on the negative electrode surface can be estimated by time of flight-secondary ion mass spectrometry (TOF-SIMS). In the spectrum obtained by TOF-SIMS, the peak at m/z=165 may be derived from components contained in the negative electrode coating-film. For example, as described later, the positive electrode coating-film and the negative electrode coating-film can be formed by performing aging on the battery in a state where an additive such as lithium difluoro bis(oxalato)phosphate (LiDFBOP) is contained in the electrolyte, and the peak at m/z=165 may be a detection peak of anions derived from LiDFBOP. In the spectrum obtained by TOF-SIMS, the peak at m/z=16 is a detection peak of oxygen anions (O⁻). The oxygen anions detected by the TOF-SIMS analysis for the negative electrode surface may be derived from an oxide as an active material such as a lithium-containing titanium oxide, or may be derived from oxygen contained in the negative electrode coating-film. It is preferable that m/z=165 negative ion count NI¹⁶⁵ and m/z=16 negative ion count NI¹⁶ satisfy the relationship of 0.12<NI¹⁶⁵/NI¹⁶<0.18. In the negative electrode satisfying the relationship, the amount of the negative electrode coating-film is appropriate from the viewpoint of suppression of gas generation and input/output performance.

Hereinafter, the battery according to the embodiment will be described in detail. The nonaqueous electrolyte battery may include an electrode group. The electrode group includes a positive electrode, a negative electrode, and a separator positioned between the positive electrode and the negative electrode. The positive electrode may include a positive electrode current-collecting tab electrically connected to the electrode group. The negative electrode may include a negative electrode current-collecting tab electrically connected to the electrode group.

The nonaqueous electrolyte battery may further include a container member. The electrode group may be housed in the container member. The container member may house the nonaqueous electrolyte. The electrode group housed in the container member may be impregnated with the nonaqueous electrolyte.

The nonaqueous electrolyte battery may further include a positive electrode terminal and a negative electrode terminal. The positive electrode terminal can have a part thereof be electrically connected to a part of the positive electrode, to serve as a conductor for transferring electrons between the positive electrode and an external terminal. The positive electrode terminal can be connected to, for example, a positive electrode current collector, particularly the positive electrode current-collecting tab. Similarly, the negative electrode terminal can have a part thereof be electrically connected to a part of the negative electrode, to serve as a conductor for transferring electrons between the negative electrode and an external terminal. The negative electrode terminal can be connected to, for example, a negative electrode current collector, particularly the negative electrode current-collecting tab.

The nonaqueous electrolyte battery may be, for example, a secondary battery. Furthermore, the secondary battery includes, for example, a lithium ion secondary battery containing lithium ions as a charge carrier.

### (1) Positive Electrode

The positive electrode includes a positive electrode current collector and a positive electrode active material-containing layer supported on one or both surfaces of the positive electrode current collector.

The positive electrode active material-containing layer contains a lithium-containing nickel-cobalt-manganese oxide as a first positive electrode active material. The lithium-containing nickel-cobalt-manganese oxide includes, for example, LiNi_{1-y-z}Co_{y}Mn_{z}O₂. Here, each subscript is in the ranges of 0<y<1, 0<z<1, and 0<y+z<1.

The positive electrode active material may contain another compound as a second positive electrode active material, in addition to the first positive electrode active material. The second positive electrode active material may contain, for example, one or more compounds selected from the group consisting of a lithium-containing manganese oxide, a lithium-containing cobalt oxide, manganese dioxide, a lithium-manganese composite oxide, a lithium-containing nickel oxide, a lithium-containing nickel-cobalt composite oxide, a lithium-containing manganese-cobalt oxide, a lithium-containing iron oxide, a lithium-containing vanadium oxide, and a chalcogen compound such as titanium disulfide and molybdenum disulfide.

The lithium-containing manganese oxide includes, for example, spinel-type lithium manganate represented by Li_{w}Mn₂O₄, and Li_{w}MnO₂. The subscript w is 0.9 to 1.2. Other examples of the lithium-containing manganese oxide include a spinel-type lithium manganate which is a composite oxide represented by the chemical formula LiMn₂₋ₓMₓO₄. Here, M is at least one selected from the group consisting of Mg, Ti, Cr, Fe, Co, Zn, Al, and Ga. The subscript x is 0.22 to 0.7.

Examples of the lithium-containing cobalt oxide include Li_{w}CoO₂. The subscript w in the chemical formula Li_{w}CoO₂ is in the range of 0<w≤1. Examples of the lithium-containing nickel oxide includes Li_{w}NiO₂ (0.9≤w≤1.2). Examples of the lithium-containing nickel-cobalt composite oxide includes LiNi_{1-y}Co_{y}O₂ (here 0<y<1). Examples of the lithium-containing manganese-cobalt oxide includes LiMn_{y}Co_{1-y}O₂ (here 0<y<1).

Among the positive electrode active materials in the positive electrode active material-containing layer, the first positive electrode active material (lithium-containing nickel-cobalt-manganese oxide) preferably accounts for 50 mass % to 100 mass %, and more preferably 70 mass % to 100 mass %.

The positive electrode active material is, for example, particulate. When the positive electrode active material is particulate, the positive electrode active material may be primary particles or secondary particles formed by aggregation of primary particles.

The average particle size of the particles of the first positive electrode active material is preferably 0.05 μm to 30 μm.

The positive electrode active material-containing layer may contain a binder and an electro-conductive agent, as necessary.

The binder may bind the active material and the electro-conductive agent. Examples of the binder include polytetrafluoroethylene (PTFE), polyvinylidene fluoride (PVdF), and fluororubber. The species of the binder to be used may be one species or two species or more.

The electro-conductive agent can increase the electron conductivity and suppress the contact resistance with the current collector. Examples of the electro-conductive agent include carbonaceous materials such as acetylene black, carbon black, graphite, carbon nanofibers, and carbon nanotubes. The species of the electro-conductive agent to be used may be one species or two species or more.

Blending ratios of the positive electrode active material, the electro-conductive agent, and the binder are preferably in a range of 80 mass % to 95 mass % for the positive electrode active material, 3 mass % to 18 mass % for the electro-conductive agent, and 2 mass % to 7 mass % for the binder, respectively.

As the current collector, for example, a sheet containing a material with high electrical conductivity can be used. For example, an aluminum foil or an aluminum alloy foil may be used as the current collector. In a case where the aluminum foil or the aluminum alloy foil is used, a thickness thereof is preferably 20 μm or less. The aluminum alloy foil can include magnesium (Mg), titanium (Ti), zinc(Zn), manganese (Mn), silicon (Si), and the like. Further, the aluminum alloy foil may contain other transition metals. The content of transition metals in the aluminum alloy foil is preferably 1% by mass or less. Examples of the other transition metals include iron (Fe), copper (Cu), nickel (Ni), and chromium (Cr), for example.

The current collector is preferably aluminum foil or an aluminum alloy foil containing aluminum and at least one element selected from the group consisting of Mg, Ti, Zn, Mn, Fe, Cu, and Si.

The current collector may include a portion that does not support the active material-containing layer on the surface thereof. This portion can serve, for example, as a positive electrode current-collecting tab. Alternatively, the positive electrode may further include a positive electrode current-collecting tab separate from the positive electrode current collector. The separate positive electrode current-collecting tab may be electrically connected to the positive electrode.

The density of the positive electrode active material-containing layer is preferably 2.5 g/cm³ to 3.1 g/cm³.

The basis weight of the positive electrode active material-containing layer, that is, the weight per unit area (g/m²) can be set to 30 g/m² to 130 g/m².

In the production of the positive electrode, first, for example, the positive electrode active material, the positive electrode electro-conductive agent, and the binder are suspended in an appropriate solvent, and the obtained slurry is applied onto the positive electrode current collector and dried to produce a positive electrode active material-containing layer, which is then pressed. Otherwise, the positive electrode active material, the positive electrode electro-conductive agent, and the binder may be formed into pellets, and used as a positive electrode active material-containing layer.

### (2) Negative Electrode

The negative electrode includes a negative electrode current collector and a negative electrode active material-containing layer supported on one or both surfaces of the negative electrode current collector. The negative electrode active material-containing layer contains at least a lithium titanium-containing oxide as a negative electrode active material.

The negative electrode current collector may include a portion that does not support the negative electrode active material-containing layer on the surface thereof. This portion can serve as a negative electrode current-collecting tab. Alternatively, the negative electrode may include a negative electrode current-collecting tab separate from the negative electrode current collector.

Examples of the lithium titanium-containing oxide include a lithium titanium oxide, a lithium titanium composite oxide in which a part of the constituent elements of the lithium titanium oxide is substituted with a different element, an orthorhombic lithium titanium-containing oxide, and a monoclinic lithium niobium titanium-containing oxide.

Examples of the lithium titanium oxide include lithium titanate having a spinel-type structure (for example, Li₄₊ₓTi₅O₁₂ (where x varies with charging and discharging, and 0≤x≤3)) and ramsdellite-type lithium titanate (for example, Li_{2+y}Ti₃O₇ (where y varies with charging and discharging, and 0≤y≤3)). On the other hand, the molar ratio of oxygen is formally shown as 12 for spinel-type Li₄₊ₓTi₅O₁₂ and 7 for ramsdellite-type Li_{2+y}Ti₃O₇, but these values may vary depending on the influence of oxygen nonstoichiometry and the like. The species of the negative electrode active material may be one species or two species or more.

Examples of the orthorhombic lithium titanium-containing oxide includes a compound represented by the general formula Li_{2+w}Na₂₋ₓM1_{y}Ti_{6-z}M2_{z}O_{14+δ}, where M1 is Cs and/or K, M2 includes at least one of Zr, Sn, V, Nb, Ta, Mo, W, Fe, Co, Mn, and Al, 0≤w≤4, 0≤x≤2, 0≤y≤2, 0≤z≤6, and −0.5≤δ≤0.5.

Examples of the monoclinic lithium niobium titanium-containing oxide include a compound represented by the general formula LiₓTi_{1-y}M3_{y}Nb_{2-z}M4_{z}O_{7+δ}, where M3 is at least one selected from the group consisting of Zr, Si, Sn, Fe, Co, Mn and Ni, and M4 is at least one selected from the group consisting of V, Nb, Ta, Mo, W and Bi, 0≤x≤5, 0≤y≤1, 0≤z<2, and −0.3≤δ≤0.3.

The lithium titanium-containing oxide is, for example, particulate. When the lithium titanium-containing oxide is particulate, the lithium titanium-containing oxide may be primary particles or secondary particles formed by aggregation of primary particles.

Among the negative electrode active materials in the negative electrode active material-containing layer, the lithium titanium-containing oxide preferably accounts for 50 mass % to 100 mass %, and more preferably 70 mass % to 100 mass %. More preferably, the negative electrode active material contains 50 mass % to 100 mass % of lithium titanate having a spinel-type structure (for example, Li₄₊ₓTi₅O₁₂; 0≤x≤3). Even more preferably, the negative electrode active material contains 70 mass % to 100 mass % of lithium titanate having a spinel-type structure.

The negative electrode active material-containing layer may contain an electro-conductive agent and a binder, as necessary.

Examples of the binder include polytetrafluoroethylene (PTFE), polyvinylidene fluoride (PVdF), fluororubber, styrene-butadiene rubber (SBR), carboxymethyl cellulose (CMC), polyimide, and polyamide. The species of the binder may be one species or two species or more.

Examples of the negative electrode electro-conductive agent include carbon black such as acetylene black and Ketjen black, graphite, carbon fiber, carbon nanotube, and fullerene. The species of the electro-conductive agent may be one species or two species or more.

In the negative electrode active material-containing layer, blending ratios of the negative electrode active material, the electro-conductive agent, and the binder are preferably within the range of 70 mass % to 96 mass % for the negative electrode active material, 2 mass % to 28 mass % for the electro-conductive agent, and 2 mass % to 28 mass % for the binder, respectively.

The density of the negative electrode active material-containing layer is preferably 2.0 g/cm³ or more.

The average particle size of the particles contained in the negative electrode active material-containing layer is preferably 0.3 μm to 1.5 μm. Gas generation from the negative electrode increases in proportion to the specific surface area of the lithium titanium-containing oxide contained as the negative electrode active material. By using the lithium titanium-containing oxide having an appropriate particle size as the negative electrode active material, a battery having a high output can be provided while further suppressing gas generation. The average particle size of the particles in the negative electrode active material-containing layer is, for example, a particle size (D₅₀) at which the volume based cumulative frequency from the smaller particle size side of the cumulative frequency distribution is 50% in the particle size distribution of the negative electrode active material obtained by a laser diffraction-scattering method.

The current collector is preferably an aluminum foil or an aluminum alloy foil. When an aluminum foil or an aluminum alloy foil is used, the thickness thereof is preferably 20 μm or less. The aluminum alloy foil may contain magnesium (Mg), titanium (Ti), zinc (Zn), manganese (Mn), silicon (Si), and the like. The aluminum alloy foil may contain other transition metals. The content of the transition metal in the aluminum alloy foil is preferably 1 mass % or less. Examples of the transition metal include iron (Fe), copper (Cu), nickel (Ni), and chromium (Cr). The current collector is preferably an aluminum foil or an aluminum alloy foil containing aluminum and one or more elements selected from the group consisting of Mg, Ti, Zn, Mn, Fe, Cu, and Si.

The negative electrode is produced by, for example, suspending a negative electrode active material, a negative electrode electro-conductive agent, and a binder in an appropriate solvent, applying the obtained slurry to a negative electrode current collector, and drying the slurry to produce a negative electrode active material-containing layer, and then pressing the negative electrode active material-containing layer. Otherwise, the negative electrode active material, the negative electrode electro-conductive agent, and the binder may be formed into pellets, and used as a negative electrode active material-containing layer.

The basis weight of the negative electrode active material-containing layer, that is, the mass per unit area (g/m²) can be set to 10 g/m² to 80 g/m².

### (3) Nonaqueous Electrolyte

Examples of the nonaqueous electrolyte include a liquid nonaqueous electrolyte prepared by dissolving an electrolyte salt in a nonaqueous solvent, and a gel nonaqueous electrolyte obtained by combining a liquid nonaqueous electrolyte and a polymeric material into a composite.

Examples of the electrolyte salt include lithium salts such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), lithium bistrifluoromethylsulfonylimide (LiN(CF₃SO₂)₂), and lithium aluminum tetrafluoride (LiAlF₄). These electrolytes may be used alone or in combination of two or more. The electrolyte salt preferably contains lithium hexafluorophosphate.

The electrolyte salt is preferably dissolved in a nonaqueous solvent in a range of 0.5 mol/L to 2.5 mol/L.

Examples of the nonaqueous solvent include organic solvents of cyclic carbonates such as ethylene carbonate (EC), propylene carbonate (PC), and vinylene carbonate (VC); linear carbonates such as dimethyl carbonate (DMC), ethyl methyl carbonate (EMC), and diethyl carbonate (DEC); cyclic ethers such as tetrahydrofuran (THF) and 2-methyl tetrahydrofuran (2MeTHF); linear ethers such as dimethoxyethane (DME); cyclic esters such as γ-butyrolactone (BL); linear esters such as methyl acetate, ethyl acetate, methyl propionate, and ethyl propionate; acetonitrile (ANl); and sulfolane (SL). These organic solvents can be used alone or in the form of a mixture of two species or more.

Examples of the polymeric material used in the gel nonaqueous electrolyte include polyvinylidene fluoride (PVdF), polyacrylonitrile (PAN), and polyethylene oxide (PEO).

### (4) Separator

The material for the separator is not particularly limited. The separator desirably has electrically insulating properties. As the separator, for example, a porous film, a microporous film, a woven fabric, or a nonwoven fabric may be used, or there may be used a laminate of the same or different materials among the above. Examples of materials for forming the separator include polymers such as polyethylene, polypropylene, ethylene-propylene copolymer, ethylene-butene copolymer, polyolefin, cellulose, polyethylene terephthalate, or vinylon. One kind of material may be used as the material of the separator, or two kinds or more may be used in combination.

The thickness of the separator is preferably 2 μm or more and 30 μm or less.

### (5) Electrode Group

In the electrode group, the positive electrode active material-containing layer and the negative electrode active material-containing layer may face each other, for example, with the separator interposed therebetween. The electrode group may have various structures. For example, the electrode group may have a stacked structure. The electrode group having a stacked structure can be obtained by, for example, alternately stacking a plurality of positive electrodes and a plurality of negative electrodes with the separator provided between the positive electrode active material-containing layer and the negative electrode active material-containing layer. Alternatively, the electrode group may have a wound structure. The wound electrode group can be obtained by, for example, stacking one separator, one negative electrode, another separator, and one positive electrode in this order to form a stack, and then winding the stack. In addition, instead of using multiple separators, one separator may be used in a folded-back state. For example, one separator may be folded in zigzag.

### (6) Container Member

The container member houses the electrode group and the nonaqueous electrolyte. Inside the container member, the nonaqueous electrolyte may be impregnated into the electrode group. A part of each of the positive electrode terminal and the negative electrode terminal may be extended outside the container member.

The container member may be formed from a laminate film or may be composed of a metal container. In the case of using the metal container, the lid and the container may be integrated or be separate members. The plate thickness of the metal container may be 0.5 mm or less, and more preferably 0.2 mm or less. Examples of the shape of the container member include a flat type, a prismatic type, a cylindrical type, a coin type, a button type, a sheet type, and a stacked type. Other than a small-sized battery installed in a portable electronic device or the like, the battery may be a large-sized battery installed in a two-wheeled to four-wheeled vehicle.

The sheet thickness of the container member made of the laminate film is desirably 0.2 mm or less. Examples of the laminate film include a multilayer film including resin films and a metal layer disposed between the resin films. The metal layer is preferably an aluminum foil or an aluminum alloy foil for weight reduction. For example, a polymer material such as polypropylene (PP), polyethylene (PE), nylon, or polyethylene terephthalate (PET) may be used for the resin films. The laminate film can be molded into the shape of the container member by sealing with thermal fusion bonding.

The metal container is made of aluminum, an aluminum alloy, or the like. As the aluminum alloy, an alloy containing an element such as magnesium, zinc, or silicon is preferable. In the aluminum or aluminum alloy, the content of transition metals such as iron, copper, nickel, and chromium is preferably 100 ppm or less, so as to drastically improve long term reliability under a high temperature environment and heat releasing properties.

The metal container made of aluminum or aluminum alloy desirably has an average crystal grain size of 50 μm or less, more preferably 30 μm or less, and further preferably 5 μm or less. With the average crystal grain size being 50 μm or less, the strength of the metal container made of aluminum or aluminum alloy can be drastically increased, allowing the container to have even thinner walls. As a result, a light weight and high output nonaqueous electrolyte battery with excellent long period reliability, which is suitable for onboard use and the like, can be realized.

Next, specific examples of the nonaqueous electrolyte battery according to the embodiment will be described with reference to the drawings.

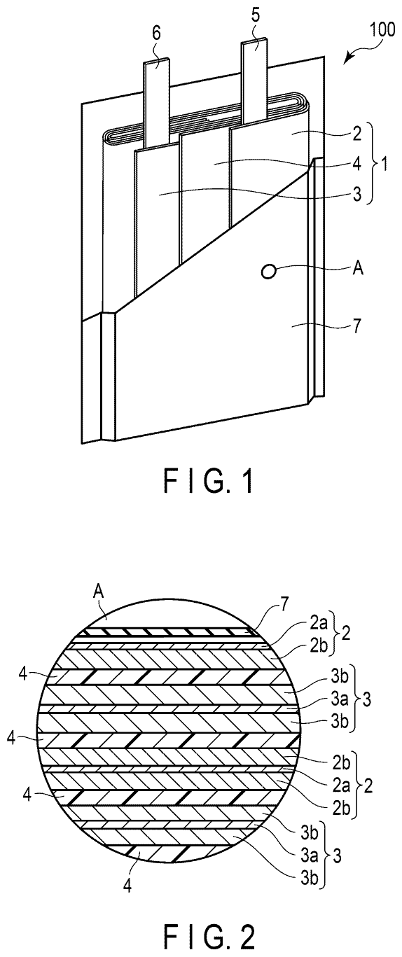

First, with reference to FIGS. 1 and 2, one example of the nonaqueous electrolyte battery will be described.

FIG. 1 is a partially cutaway perspective view of an example of the nonaqueous electrolyte secondary battery according to the embodiment. FIG. 2 is an enlarged sectional view of section A of the nonaqueous electrolyte battery shown in FIG. 1.

The nonaqueous electrolyte battery 100 shown in FIGS. 1 and 2 includes a flat electrode group 1 and a container member 7 made of laminate film. The flat electrode group 1 includes a negative electrode 2, a positive electrode 3, and a separator 4. The flat electrode group 1 is formed by spirally winding in a flat shape, the negative electrode 2 and positive electrode 3 with the separator 4 interposed therebetween.

As shown in FIG. 2, the negative electrode 2 includes a negative electrode current collector 2a, and a negative electrode active material-containing layer 2b supported on the negative electrode current collector 2a. As shown in FIG. 2, in the portion located on the outermost side of the negative electrode 2, of the two principal faces of the negative electrode current collector 2a, the principal face not facing the positive electrode 3 does not have the negative electrode active material-containing layer 2b provided thereon. In the other portions of the negative electrode 2, negative electrode active material-containing layers 2b are supported on both principal faces of the negative electrode current collector. As shown in FIG. 2, the positive electrode 3 includes a positive electrode current collector 3a, and positive electrode active material-containing layers 3b supported on the two principal faces of the positive electrode current collector 3a.

A belt-like negative electrode terminal 5 is electrically connected to the negative electrode 2. A belt-like positive electrode terminal 6 is electrically connected to the positive electrode 3.

The electrode group 1 is accommodated in the container member 7 made of laminate film with an end of each of the negative electrode terminal 5 and the positive electrode terminal 6 being extended out from the container member 7. The container member 7 made of laminate film accommodates a nonaqueous electrolyte, which is not shown. The electrode group 1 is impregnated with the nonaqueous electrolyte. The container member 7 made of laminate film is sealed in a state where the negative electrode terminal 5 and the positive electrode terminal 6 are sandwiched at one end, by having this end and the two ends crossing this end being thermally fusion bonded.

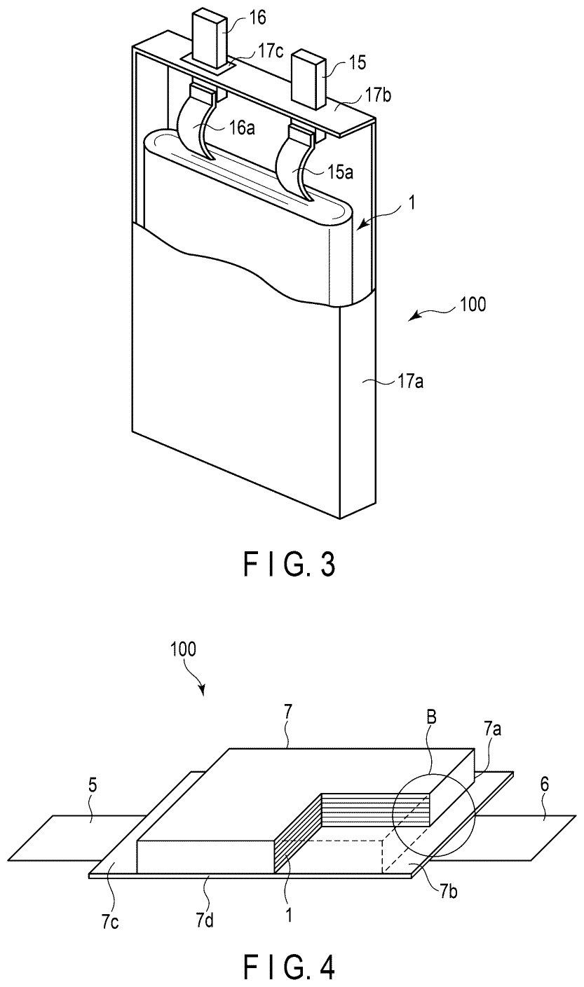

Next, another example of the battery according to the embodiment will be described in detail with reference to FIG. 3. FIG. 3 is a partially cutaway perspective view illustrating another example of the battery according to the embodiment.

A battery 100 illustrated in FIG. 3 differs from the battery 100 illustrated in FIGS. 1 and 2 in that the container member is configured by a metal container 17a and a sealing plate 17b.

A flat electrode group 1 includes a negative electrode, a positive electrode, and a separator, similar to the electrode group 1 in the battery 100 illustrated in FIGS. 1 and 2. Between FIG. 1 and FIG. 3, the electrode group 1 has a similar structure. However, in FIG. 3, a negative electrode lead 15a and a positive electrode lead 16a are electrically connected to the negative electrode and the positive electrode, respectively, instead of the negative electrode terminal 5 and the positive electrode terminal 6, as described later.

In the battery 100 illustrated in FIG. 3, such an electrode group 1 is accommodated in a metal container 17a. The metal container 17a further houses an electrolyte, which is not shown. The metal container 17a is sealed by a metal sealing plate 17b. The metal container 17a and the sealing plate 17b constitute, for example, a container can as a container member.

One end of the negative electrode lead 15a is electrically connected to the negative electrode current collector, and the other end is electrically connected to the negative electrode terminal 15. One end of the positive electrode lead 16a is electrically connected to the positive electrode current collector, and the other end is electrically connected to the positive electrode terminal 16 fixed to the sealing plate 17b. The positive electrode terminal 16 is fixed to the sealing plate 17b via an insulating member 17c. The positive electrode terminal 16 and the sealing plate 17b are electrically insulated by the insulating member 17c.

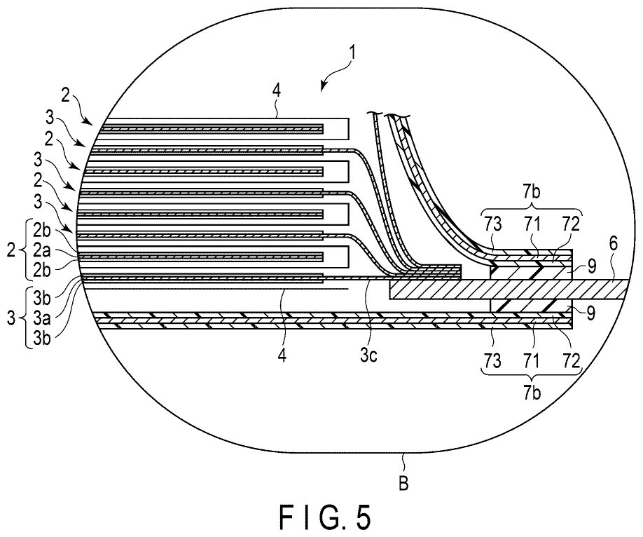

In FIG. 4 and FIG. 5, as a further other example of the battery, a battery including a stacked electrode group is shown. FIG. 4 is a partially cutout perspective view of the further other example of the battery according to the embodiment. FIG. 5 is an enlarged sectional view of section B of the battery shown in FIG. 4.

The battery 100 of the example shown in FIG. 4 and FIG. 5 includes an electrode group 1 shown in FIGS. 4 and 5, a container member 7 shown in FIGS. 4 and 5, a positive electrode terminal 6 shown in FIGS. 4 and 5, and a negative electrode terminal 5 shown in FIG. 4.

The electrode group 1 shown in FIGS. 4 and 5, includes a plurality of positive electrodes 3, a plurality of negative electrodes 2, and one separator 4.

Each positive electrode 3 includes a positive electrode current collector 3a and positive electrode active material-containing layers 3b formed on both sides of the positive electrode current collector 3a, as shown in FIG. 5. The positive electrode current collector 3a includes a portion where the positive electrode active material-containing layer 3b is not formed on either surface, as shown in FIG. 5. This portion functions as a positive electrode current collecting tab 3c.

Each negative electrode 2 includes a negative electrode current collector 2a and negative electrode active material-containing layers 2b formed on both sides of the negative electrode current collector 2a. The negative electrode current collector 2a includes a portion where the negative electrode active material-containing layer 2b is not formed on either surface (not shown). This portion functions as a negative electrode current collecting tab.

As with a part thereof shown in FIG. 5, the separator 4 is folded in zigzag. In each of spaces defined by surfaces facing each other of the separator 4 folded in zigzag, either of the positive electrode 3 or the negative electrode 2 is disposed. Accordingly, the positive electrodes 3 and the negative electrodes 2 are stacked so that the positive electrode active material-including layer 3b and the negative electrode active material-including layer 2b face each other through the separator 4 sandwiched therebetween, as shown in FIG. 5. Thus, the electrode group 1 is formed.

The positive electrode current collecting tabs 3c of the electrode group 1 extend further out than each of the ends of the positive electrode active material-containing layers 3b and the negative electrode active material-containing layers 2b, as shown in FIG. 5. The positive electrode current collecting tabs 3c are, as shown in FIG. 5, collected into one and connected to the positive electrode terminal 6. Although not shown, the negative electrode current collecting tabs of the electrode group 1 also extend further out than each of the other ends of the positive electrode active material-containing layers 3b and the negative electrode active material-containing layers 2b. Though not shown, the negative electrode current collecting tabs are collected into one and connected to the negative electrode terminal 5 shown in FIG. 4.

Such an electrode group 1 is housed in a container member 7 composed of an exterior container made of laminate film, as shown in FIGS. 4 and 5.

The container member 7 is formed of an aluminum-containing laminate film made of an aluminum foil 71 and resin films 72 and 73 formed on both sides thereof. The aluminum-containing laminate film forming the container member 7 is folded with a folding section 7d being a fold so that the resin film 72 faces inward, and houses the electrode group 1. As shown in FIGS. 4 and 5, at the periphery 7b of the container member 7, portions of the resin films 72 that face one another hold the positive electrode terminal 6 therebetween. Similarly, at the periphery 7c of the container member 7, portions of the resin films 72 that face one another hold the negative electrode terminal 5 therebetween. The positive electrode terminal 6 and the negative electrode terminal 5 extend out from the container member 7 in opposite directions from each other.

At the peripheries 7a, 7b and 7c of the container member 7 excluding the portions holding the positive electrode terminal 6 and the negative electrode terminal 5, portions of the resin film 72 facing each other are thermally fusion bonded.

In the battery 100, in order to improve bonding strength between the positive electrode terminal 6 and the resin film 72, insulating films 9 are provided between the positive electrode terminal 6 and the resin films 72, as shown in FIG. 5. In the periphery 7b, the positive electrode terminal 6 and the insulating film 9 are thermally fusion bonded, and the resin film 72 and the insulating film 9 are thermally fusion bonded. Similarly, although not shown, insulating films 9 are also provided between the negative electrode terminal 5 and the resin films 72. In the periphery 7c, the negative electrode terminal 5 and the insulating film 9 are thermally fusion bonded, and the resin film 72 and the insulating film 9 are thermally fusion bonded. Namely, in the battery 100 shown in FIG. 5, all of the peripheries 7a, 7b and 7c of the container member 7 are heat-sealed.

The container member 7 further houses an electrolyte, which is not shown. The electrolyte is impregnated into the electrode group 1.

In the battery 100 shown in FIGS. 4 and 5, the multiple positive electrode current collecting tabs 3c are collected at the undermost of the electrode group 1, as shown in FIG. 5. Similarly, although not shown, the multiple negative electrode current collecting tabs are collected at the undermost of the electrode group 1. The multiple positive electrode current collecting tabs 3c and the multiple negative electrode current collecting tabs may, however, instead be respectively collected into one near a middle of the electrode group 1, and connected to the positive electrode terminal 6 and the negative electrode terminal 5, respectively, for example.

The battery according to the embodiment can be produced, for example, as follows. A positive electrode, a negative electrode, and a separator are prepared. The positive electrode and the negative electrode are produced, for example, by the method described above. An electrode group may be produced using the positive electrode, the negative electrode, and the separator. An electrode group is produced by stacking at least one each of these members so as to have a structure in which the separator is interposed between the positive electrode and the negative electrode, and pressing or spirally winding the obtained stack as necessary. In addition, a container member, a positive electrode terminal, and a negative electrode terminal are prepared. As the container member, the positive electrode terminal, and the negative electrode terminal, those described above can be used. The positive electrode terminal is electrically connected to the positive electrode, and the negative electrode terminal is electrically connected to the negative electrode.

Members other than the nonaqueous electrolyte are housed in the container member. The residual moisture is removed by drying at a temperature of 95° C. or more for 6 hours or more. A separately prepared nonaqueous electrolyte is injected into the container member under a dry environment with a dew point of −50° C. or less, and the container member is sealed under a reduced pressure environment. The nonaqueous electrolyte can be prepared by dissolving the electrolyte salt and other additives in the nonaqueous solvent described above. The battery precursor obtained by enclosing the other members within the container member is subjected to aging as follows. After the battery precursor is charged to a battery voltage of 2 V to 2.7 V, aging is performed by holding the battery precursor in a high-temperature environment of 60° C. to 80° C. for 20 hours to 100 hours. After aging, a part of the container member is opened, and the container member is sealed again under a reduced pressure environment. In this manner, the nonaqueous electrolyte battery according to the embodiment can be obtained.

By performing the aging in a state where an appropriate additive is contained in the nonaqueous electrolyte battery, a fluorine-containing coating-film is formed on the positive electrode surface and the negative electrode surface. Examples of such additives include fluorine-containing phosphates such as difluorophosphoric acid (HPO₂F₂; DFP), lithium difluorophosphate (LiPO₂F₂; LiDFP), and lithium difluoro bis(oxalato)phosphate (LiDFBOP). One species of the fluorine-containing phosphate may be added, or two species or more of the fluorine-containing phosphates may be added in combination. In addition to the fluorine-containing phosphates, silane compounds such as vinylene carbonate (C₃H₂O₃) or trimethylvinylsilane (C₅H₁₂Si) may be further added as additives that contribute to formation of the coating-film that suppresses gas generation

The chemical formula of LiDFBOP is shown below.

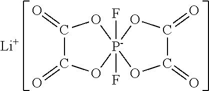

In the following description, a method of measuring the electrode active material, a method of analyzing the electrode surface by X-ray photoelectron spectroscopy (XPS), and a method of analyzing the electrode surface by time of flight-secondary ion mass spectrometry (TOF-SIMS) will be described. First, a method of taking out an electrode will be described.

### <Method of Taking Out Electrode>

The battery is discharged at 0.2 C to 1.5 V to put the battery in a discharged state. The battery is disassembled and the electrode group is taken out. 2 cm×2 cm squares each of the positive electrode and the negative electrode are cut out from the taken-out electrode group. Each cut-out electrode is immersed in an ethyl methyl carbonate (EMC) solvent and left standing for 1 hour. Thereafter, in order to dry the electrode, vacuum drying is performed for 12 hours under a reduced pressure environment of −90 kPa, thereby obtaining a measurement sample. The operation so far is performed in a glove box in an argon atmosphere.

### <Measurement of Composition of Active Material>

The composition of the active material contained in the electrode can be measured as follows.

From the electrode as a measurement sample, the active material-containing layer is etched off with, for example, a spatula or the like to obtain a powdery sample.

By powder X-Ray diffraction (XRD) measurement on the powdery sample, the crystal structure of the active material is identified. The measurement is performed using Cu Kα rays as a radiation source in a measurement range in which 20 is 10° to 90°. By this measurement, X-ray diffraction patterns of the compounds contained in the selected particles can be obtained.

As a device for powder X-ray diffraction measurement, for example, SmartLab manufactured by Rigaku Corporation is used. The measurement conditions are as follows.
X-ray source: Cu target
Output: 45 kV, 200 mA
Soller slit: 5° for both incidence and reception
Step width: 0.02 deg
Scan speed: 20 deg/min
Semiconductor detector: D/teX Ultra 250
Sample plate holder: Flat glass sample plate holder (thickness 0.5 mm)
Measurement range: in a range of 10°2θ<90°

In the case of using other devices, measurement is performed using standard Si powder for powder X-ray diffraction so as to obtain measurement results equivalent to those described above, and measurement is performed by adjusting the conditions so that the peak intensity and the peak top position match those of the above-described device.

Subsequently, the sample containing the active material is observed with a scanning electron microscope (SEM). SEM observation is desirably performed in an inert atmosphere of argon, nitrogen, or the like, in such a manner that the sample does not come into contact with the air.

For example, in a SEM observation image at a magnification of 3000 times, some particles having the form of primary particles or secondary particles confirmed in the field of view are selected. At this time, the particles are selected so that the particle size distribution of the selected particles is as wide as possible. The observed active material particles are analyzed by energy dispersive X-ray spectroscopy (EDX) to identify types and compositions of the constituent elements of the active material. Thus, the species and the amount of elements other than Li among the elements contained in the respective selected particles can be identified. The same operation is performed on each of the plurality of active material particles to determine a mixed state of the active material particles.

Subsequently, the powdery sample collected from the active material-containing layer as described above is washed with acetone and dried. The obtained powder is dissolved in hydrochloric acid, the electro-conductive agent is removed by filtration, and then the solution is diluted with ion exchange water, thereby preparing a measurement sample. The metal content ratio in the measurement sample is calculated by inductively coupled plasma atomic emission spectroscopy (ICP-AES).

If there are a plurality of species of active materials, the mass ratio is estimated from the content ratio of the element specific to each active material. The ratio of the specific element to the mass of the active material is determined from the composition of the constituent element determined by EDX analysis.

### <Electrode Surface Analysis by X-Ray Photoelectron Spectroscopy>

The surface analysis of the electrode surface by X-ray photoelectron spectroscopy (XPS) can be performed as follows. An XPS spectrum is obtained by performing XPS measurement on the measurement sample obtained by cutting out the pieces from each of the positive electrode and the negative electrode, washing them with EMC, and drying them as described above. K-Alpha⁺ manufactured by Thermo Fisher Scientific Inc. is used as a measurement device, and AlKα rays are used as excitation X-rays. The measurement is performed in an inert atmosphere.

For the positive electrode, a peak intensity P^{Li—F} (unit: counts) of the highest intensity peak, appearing in the bonding energy region of 682 eV to 685 eV, which is attributed to the Li—F bond in the F 1S orbital, is determined from the obtained XPS spectrum. The peak intensity P^{Ni} (unit: counts) of the highest intensity peak appearing in the bonding energy region of 850 eV to 858 eV, which is attributed to the Ni 2p3 orbital, is also determined from the XPS spectrum obtained for the positive electrode. The ratio P^{Li—F}/P^{Ni} thereof is calculated from the obtained peak intensities.

For the negative electrode, a peak intensity N^{Li—F} (unit: counts) of the highest intensity peak appearing in the bonding energy region of 682 eV to 685 eV, which is attributed to the Li—F bond in the F is orbital, is determined from the obtained XPS spectrum. The peak intensity N^{Ti} (unit: counts) of the highest intensity peak appearing in the bonding energy region of 454 eV to 460 eV, which is attributed to the Ti 2p3 orbital, is also determined from the XPS spectrum obtained for the negative electrode. The ratio N^{Li—F}/N^{Ti} thereof is calculated from the obtained peak intensities.

### <Electrode Surface Analysis by Time of Flight-Secondary Ion Mass Spectrometry>

The surface analysis for the electrode surface by time of flight-secondary ion mass spectrometry (TOF-SIMS) can be performed as follows. The surface analysis by TOF-SIMS is performed using the measurement sample obtained by cutting out the piece from the negative electrode, washing it with EMC, and drying it, as described above. As a measurement device, the time of flight-secondary ion mass spectrometer TOF.SIMS⁵ manufactured by ION-TOF is used, and ²⁰⁹Bi3⁺⁺ is used as a primary ion, performing measurement for the measurement range of approximately 500 μm×500 μm.

The negative ion count NI¹⁶⁵ (unit: counts) at the m/z=165 peak and the negative ion count NI¹⁶ (unit: counts) at the m/z=16 peak in the obtained spectrum are determined. The former m/z=165 peak represents a fluorine-containing coating-film present on the negative electrode surface, and may be derived from, for example, an additive such as LiDFBOP added to the nonaqueous electrolyte. The latter m/z=16 peak represents oxygen anion O⁻ and is derived from oxygen on the negative electrode surface. The ratio NI¹⁶⁵/NI¹⁶ thereof is determined from the determined negative ion counts.

According to the nonaqueous electrolyte battery of the first embodiment described above, a positive electrode containing a lithium-containing nickel-cobalt-manganese oxide, a negative electrode containing a lithium titanium-containing oxide, and a nonaqueous electrolyte are included. A ratio P^{Li—F}/P^{Ni} in an X-Ray photoelectron spectrum of ther positive electrode surface is 0.6 or more and 1 or less, and a ratio N^{Li—F}/N^{Ti} in an X-Ray photoelectron spectrum of the negative electrode surface is 1.8 or more and 3 or less. According to the above nonaqueous electrolyte battery, gas generation can be suppressed to improve charge-discharge cycle life performance.

### Second Embodiment

According to a second embodiment, a battery pack is provided. The battery pack includes the nonaqueous electrolyte battery according to the first embodiment.

The battery pack according to the embodiment may include plural batteries. The plural batteries may be electrically connected in series or electrically connected in parallel. Alternatively, the plural batteries may be electrically connected in combination of in series and in parallel. Namely, the battery pack according to the embodiment may include a battery module. The number of battery modules may be plural. The plural battery modules may be electrically connected in series, in parallel, or in combination of in series and in parallel.

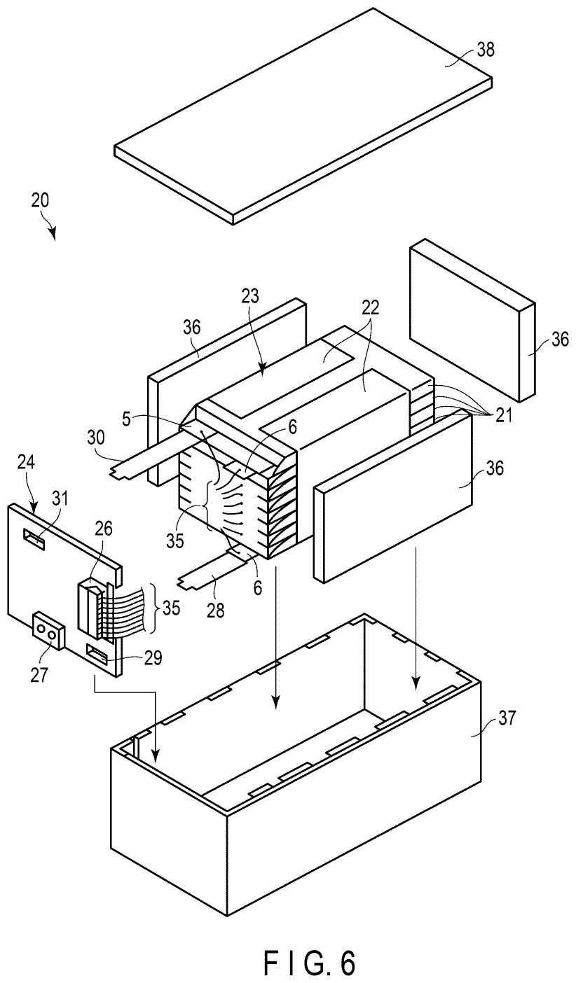

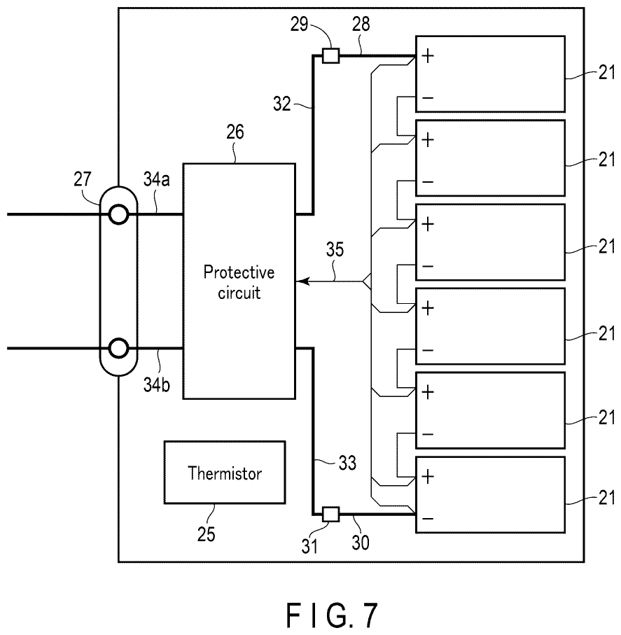

An example of the battery pack according to the embodiment will be described below with reference to FIG. 6 and FIG. 7. FIG. 6 is an exploded perspective view showing an example of the battery pack according to the embodiment. FIG. 7 is a block diagram showing an example of an electric circuit of the battery pack shown in FIG. 6.

The battery pack 20 shown in FIG. 6 and FIG. 7 includes plural single-batteries 21. The single-battery 21 may, for example, be the exemplar flat battery 100 according to the embodiment described with reference to FIG. 1.

The plural single-batteries 21 are stacked so that negative electrode terminals 5 and positive electrode terminals 6 extending outside are aligned in the same direction and are fastened with an adhesive tape 22 to configure a battery module 23. These single-batteries 21 are electrically connected in series with each other as shown in FIG. 7.

A printed wiring board 24 is disposed facing the side surface from which the negative electrode terminals 5 and the positive electrode terminals 6 of the single-batteries 21 extend. As shown in FIG. 7, the printed wiring board 24 has a thermistor 25, a protective circuit 26, and an external power distribution terminal 27 mounted thereon. An insulating plate (not shown) is attached to the surface of the printed wiring board 24, which faces the battery module 23, so as to avoid unnecessary connection with the wiring of the battery module 23.

A positive electrode side lead 28 is connected to the positive electrode terminal 6 located lowermost in the battery module 23, and its tip is inserted into a positive electrode side connector 29 of the printed wiring board 24 and electrically connected thereto. A negative electrode side lead 30 is connected to the negative electrode terminal 5 located uppermost in the battery module 23, and its tip is inserted into the negative electrode side connector 31 of the printed wiring board 24 and electrically connected thereto. These connectors 29 and 31 are connected to the protective circuit 26 through wiring 32 and the wiring 33 formed on the printed wiring board 24.

The thermistor 25 detects the temperature of the single-batteries 21, and the detection signal is transmitted to the protective circuit 26. The protective circuit 26 can shut off a plus-side wiring 34a and a minus-side wiring 34b between the protective circuit 26 and the external power distribution terminal 27 in accordance to a predetermined condition. An example of the predetermined condition is when the temperature detected by the thermistor 25 becomes a predetermined temperature or higher. Another example of the predetermined condition is when overcharge, over-discharge, overcurrent, or the like of the single-battery 21 is detected. Detection of the overcharge or the like is performed for each of the individual single-batteries 21 or the entire battery module 23. In the case of detecting each single-battery 21, a battery voltage may be detected, or a positive electrode potential or a negative electrode potential may be detected. In the latter case, a lithium electrode used as a reference electrode is inserted into each single-battery 21. For the battery pack 20 of FIG. 6 and FIG. 7, wiring 35 for voltage detection is connected to each of the single-batteries 21. Detection signals are transmitted to the protective circuit 26 through the wiring 35.

Protective sheets 36 made of rubber or resin are respectively arranged on three side surfaces of the battery module 23 excluding the side surface from which the positive electrode terminal 6 and the negative electrode terminal 5 protrude.

The battery module 23 is housed in a housing container 37 together with each protective sheet 36 and the printed wiring board 24. Namely, the protective sheets 36 are disposed in the housing container 37 respectively on both inner side surfaces along a long-side direction and an inner side surface along a short-side direction, and the printed wiring board 24 is disposed on the other inner side surface along the short-side direction on the opposite side across the battery module 23. The battery module 23 is located in a space surrounded by the protective sheets 36 and the printed wiring board 24. A lid 38 is attached to the upper surface of the housing container 37.

For fixing the battery module 23, a thermal shrinkage tape may be used in place of the adhesive tape 22. In this case, after the protective sheets are disposed on each side surface of the battery module and a thermal shrinkage tape is wound, the thermal shrinkage tape is thermally shrunk, to bind the battery module.

While FIG. 6 and FIG. 7 show a form where the single-batteries 21 are electrically connected in series, the single-batteries 21 may be electrically connected in parallel in order to increase the battery capacity. Further, assembled battery packs may also be electrically connected in series and/or parallel.

The mode of the battery pack according to the embodiment is appropriately changed depending on the application thereof. A preferable application of the battery pack according to the embodiment is one where cycle performance is desired for charge and discharge with a large current. Specific examples of the applications include that for a power source of a digital camera, and for use in a vehicle such as a two-wheeled to four-wheeled hybrid electric automobile, a two-wheeled to four-wheeled electric automobile, and a power-assisted bicycle. As the application of the battery pack according to the embodiment, onboard use is particularly favorable.

The battery pack according to the second embodiment includes the battery according to the first embodiment. Therefore, the battery pack according to the embodiment has superior life performance.

### EXAMPLES

Hereinafter, the Examples will be described in detail.

### Example 1

As a positive electrode active material, a lithium-containing nickel-cobalt-manganese oxide represented by LiNi_{0.33}Co_{0.33}Mn_{0.33}O₂ was prepared. The positive electrode active material, acetylene black as an electro-conductive agent, and polyvinylidene fluoride (PVdF) as a binder were dispersed in N-methylpyrrolidone (NMP) at a mass ratio of 90:5:5. The obtained dispersion liquid was applied onto a current collector made of an aluminum foil having a thickness of 15 μm, dried, and subjected to a pressing treatment, thereby providing a positive electrode active material-containing layer. The basis weight per side of the positive electrode was 80 g/m².

As a negative electrode active material, lithium titanate represented by Li₄Ti₅O₁₂ was prepared. The negative electrode active material, graphite as an electro-conductive agent, and polyvinylidene fluoride as a binder were dispersed in N-methylpyrrolidone (NMP) at a mass ratio of 95:3:2. The obtained dispersion liquid was applied onto a current collector made of an aluminum foil having a thickness of 15 μm, dried, and subjected to a pressing treatment, thereby providing a negative electrode active material-containing layer. The basis weight per side of the negative electrode was 80 g/m².

As a separator, a resin separator having a thickness of 15 μm was prepared. In a state in which the separator was folded in a zigzag shape in such a manner that the separator was disposed between the positive electrode and the negative electrode, these members were stacked. The obtained stack was wound to produce a spiral electrode group.

As a nonaqueous electrolyte, an electrolytic solution was prepared as follows. 1 mol/L of LiPF₆ was dissolved in a mixed solvent of diethyl carbonate (DEC) and ethylene carbonate (EC). 1 mass % of lithium difluorophosphate (LiDFP) and 1 mass % of lithium difluoro bis(oxalato)phosphate (LiDFBOP) were further added and mixed. In the mixed solvent, the proportion of DEC was 70 vol %, and the proportion of EC was 30 vol %.

Two quadrilateral laminate films were prepared. One laminate film was disposed on each of the upper and lower sides of the electrode group, and three sides of the overlapped films were heat-sealed, obtaining an electrode group wrapped with a laminate film outer container. This was put into a dryer and vacuum-dried at 95° C. for 12 hours. After drying, it was transferred to a glove box controlled to have a dew point of −50° C. or less. The prepared electrolytic solution was injected into the container. Under a reduced pressure of −90 kPa, the remaining one side of the overlapped films was heat-sealed to seal the outer container.

After the injection, initial charging was performed at 1 C until the battery voltage reached 2.7 V, and 24-hour aging was performed in a thermostatic chamber at 70° C. After the aging, one side of the laminate film container was opened, and the container was sealed again under the reduced pressure of −90 kPa. A nonaqueous electrolyte battery was thus produced.

### Examples 2 and 3

Nonaqueous electrolyte batteries were produced in the same manner as in Example 1 except that the aging conditions were changed as shown in Table 1 below.

### Examples 4 to 6

Nonaqueous electrolyte batteries were produced in the same manner as in Example 1 except that the amount of LiDFBOP added to the electrolytic solution and the aging conditions were changed as shown in Table 1 below.

### Example 7

A nonaqueous electrolyte battery was produced in the same manner as in Example 1 except that EC was changed to propylene carbonate (PC) in the mixed solvent used in preparation of the electrolytic solution.

### Example 8

A nonaqueous electrolyte battery was produced in the same manner as in Example 1 except that the amount of LiDFP added to the electrolytic solution was changed as shown in Table 1 below.

### Comparative Examples 1 and 2

Nonaqueous electrolyte batteries were produced in the same manner as in Example 1 except that the amount of LiDFBOP added to the electrolytic solution and the aging conditions were changed as shown in Table 1 below.

### Comparative Example 3

A nonaqueous electrolyte battery was produced in the same manner as in Example 1 except that the aging conditions were changed as shown in Table 1 below.

### Comparative Example 4

A nonaqueous electrolyte battery was produced in the same manner as in Example 1 except that the addition of LiDFBOP to the electrolytic solution was omitted.

### Comparative Examples 5 and 6

Nonaqueous electrolyte batteries were produced in the same manner as in Example 1 except that DEC was changed to ethyl propionate (EP) in the mixed solvent used in preparation of the electrolytic solution.

### Comparative Example 7

A nonaqueous electrolyte battery was produced in the same manner as in Example 1 except that DEC was changed to ethyl propionate (EP) in the mixed solvent used in preparation of the electrolytic solution and the addition of LiDFP was omitted.

### Comparative Example 8

A nonaqueous electrolyte battery was produced in the same manner as in Example 1 except that the amount of LiDFBOP added to the electrolytic solution and the aging conditions were changed as shown in Table 1 below.

TABLE 1

| | Electrolytic Solution | | | | |
|---|---|---|---|---|---|
| | | Additive 1 | Additive 2 | | |
| | | (LiDFP) | (LiDFBOP) | | |
| | | Addition | Addition | Aging | |
| | | Amount | Amount | Voltage | Time |
| | Solvent | (mass %) | (mass %) | (V) | (h) |
| Example 1 | EC + DEC | 1 | 1 | 2.7 | 24 |
| Example 2 | EC + DEC | 1 | 1 | 2.5 | 24 |
| Example 3 | EC + DEC | 1 | 1 | 2.2 | 24 |
| Example 4 | EC + DEC | 1 | 0.5 | 2.7 | 24 |
| Example 5 | EC + DEC | 1 | 0.5 | 2.5 | 24 |
| Example 6 | EC + DEC | 1 | 0.5 | 2.2 | 24 |
| Example 7 | PC + DEC | 1 | 1 | 2.7 | 24 |
| Example 8 | EC + DEC | 0.7 | 1 | 2.7 | 24 |
| Comparative | EC + DEC | 1 | 0.1 | 2.7 | 24 |
| Example 1 | | | | | |
| Comparative | EC + DEC | 1 | 0.1 | 2.5 | 24 |
| Example 2 | | | | | |
| Comparative | EC + DEC | 1 | 1 | 2.2 | 8 |
| Example 3 | | | | | |
| Comparative | EC + DEC | 1 | None | 2.7 | 24 |
| Example 4 | | | | | |
| Comparative | EC + EP | 1 | 1 | 2.7 | 24 |
| Example 5 | | | | | |
| Comparative | EC + EP | 1 | 1 | 2.2 | 24 |
| Example 6 | | | | | |
| Comparative | EC + EP | None | 1 | 2.7 | 24 |
| Example 7 | | | | | |
| Comparative | EC + DEC | 1 | 3 | 2.2 | 24 |
| Example 8 | | | | | |

### <Electrode Surface Analysis by X-Ray Photoelectron Spectroscopy>

For each of the positive electrode and the negative electrode of the nonaqueous electrolyte battery produced in each Example, the surface analysis by X-ray photoelectron spectroscopy (XPS) was performed as described above. The obtained results are shown in Table 2 below.

### <Electrode Surface Analysis by Time of Flight-Secondary Ion Mass Spectrometry>

For the negative electrode of the nonaqueous electrolyte battery produced in each Example, the surface analysis by time of flight-secondary ion mass spectrometry (TOF-SIMS) was performed as described above. The obtained results are shown in Table 2 below.

### <Cycle Performance Evaluation>

1C constant current charge-and-discharge cycles were performed within the voltage range of 1.5 V to 2.7 V under a 45° C. environment. The amount of gas inside the battery cell after 1000 cycles was measured. The measurement results are shown in Table 2 below.

TABLE 2

| | | | | Negative Electrode | | | Cycle Test |
|---|---|---|---|---|---|---|---|
| | XPS | | | TOF-SIMS | | | Gas Amount |
| | P^{Li—F}/P^{Ni} | N^{Li—F}/N^{Ti} | P^{Ni}/N^{Ti} | NI¹⁶⁵ | NI¹⁶ | NI¹⁶⁵/NI¹⁶ | (cm³) |
| Example 1 | 0.82 | 2.44 | 1.35 | 19200 | 112000 | 0.17 | 3.2 |
| Example 2 | 0.81 | 2.42 | 1.35 | 18600 | 115600 | 0.16 | 2.4 |
| Example 3 | 0.81 | 2.34 | 1.29 | 18200 | 117500 | 0.15 | 2 |
| Example 4 | 0.8 | 2.31 | 1.25 | 17400 | 119800 | 0.15 | 4.5 |
| Example 5 | 0.8 | 2.12 | 1.21 | 17300 | 119300 | 0.15 | 3.7 |
| Example 6 | 0.8 | 2 | 1.25 | 16900 | 121200 | 0.14 | 3.6 |
| Example 7 | 0.81 | 2.48 | 1.33 | 19800 | 113500 | 0.17 | 2.2 |
| Example 8 | 0.77 | 2.02 | 1.23 | 17800 | 118200 | 0.15 | 6.6 |
| Comparative | 0.72 | 1.75 | 1.23 | 11600 | 123000 | 0.09 | 9.5 |
| Example 1 | | | | | | | |
| Comparative | 0.71 | 1.78 | 1.25 | 11200 | 119800 | 0.09 | 8.4 |
| Example 2 | | | | | | | |
| Comparative | 0.58 | 1.7 | 1.51 | 13800 | 125400 | 0.11 | 22.4 |
| Example 3 | | | | | | | |
| Comparative | 0.65 | 1.72 | 1.16 | 9700 | 118400 | 0.08 | 23.6 |
| Example 4 | | | | | | | |
| Comparative | 1.18 | 2.52 | 1.25 | 18800 | 105200 | 0.18 | 10.5 |
| Example 5 | | | | | | | |
| Comparative | 1.08 | 2.47 | 1.25 | 17700 | 111600 | 0.16 | 8.6 |
| Example 6 | | | | | | | |
| Comparative | 1.05 | 2.22 | 1.21 | 7800 | 107200 | 0.07 | 21.4 |
| Example 7 | | | | | | | |
| Comparative | 0.8 | 3.2 | 1.68 | 26400 | 82000 | 0.32 | 11.2 |
| Example 8 | | | | | | | |

As shown in Table 2, the amount of gas generated in the batteries produced in Comparative Examples 1 to 8 was larger than that in the batteries produced in Examples 1 to 8.

In Comparative Examples 1, 2, and 4, the ratio N^{Li—F}/N^{Ti} was less than 1.8, indicating that the covering of the negative electrode active material-containing layer was insufficient. In these Examples, since there was little fluorine-containing coating-film on the negative electrode, the gas generation was not effectively suppressed. In particular, for Comparative Example 4, since the ratio P^{Ni}/N^{Ti} was low, the generation of CO in the negative electrode exceeded the oxidation treatment to CO₂ at the positive electrode, making the amount of gas generated particularly great.

In Comparative Example 3, the ratio P^{Li—F}/P^{Ni} was less than 0.6 and the ratio N^{Li—F}/N^{Ti} was less than 1.8, indicating that the covering of the active material-containing layer was insufficient for both the positive electrode and the negative electrode. In Comparative Example 3, the suppression of gas generation for both the positive electrode and the negative electrode was insufficient, making the amount of gas generated significantly great.

In Comparative Examples 5 to 7, the ratio P^{Li—F}/P^{Ni} exceeded 1, indicating that the proportion of the fluorine-containing coating-film on the positive electrode surface was great. In these Examples, the oxidation treatment of CO generated in the negative electrode to CO₂ at the positive electrode was insufficient, making the amount of gas generated great.

In Comparative Example 8, the ratio N^{Li—F}/N^{Ti} exceeded 3, indicating that the covering of the negative electrode active material-containing layer with the fluorine-containing coating-film was excessive. This resulted in an increase in the electrical resistance of the negative electrode. Consequently, the side reaction in the negative electrode was promoted, making the amount of gas generated great.

In the nonaqueous electrolyte battery according to at least one embodiment and example described above, the above described peak intensity ratio P^{Li—F}/P^{Ni} is 0.6 to 1, and the peak intensity ratio N^{Li—F}/N^{Ti} is 1.8 to 3. Therefore, the nonaqueous electrolyte battery is superior in cycle life.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinafter, several embodiments of the invention will be described.

1. A nonaqueous electrolyte battery comprising:
a positive electrode containing a lithium-containing nickel-cobalt-manganese oxide;
a negative electrode containing a lithium titanium-containing oxide; and
a nonaqueous electrolyte,
a ratio P^{Li—F}/P^{Ni} of a peak intensity P^{Li—F} of a highest intensity peak appearing in a range of 682 eV to 685 eV in an X-Ray photoelectron spectrum of a positive electrode surface of the positive electrode to a peak intensity P^{Ni} of a highest intensity peak appearing in a range of 850 eV to 858 eV in the X-Ray photoelectron spectrum of the positive electrode surface being 0.6 or more and 1 or less, and
a ratio N^{Li—F}/N^{Ti} of a peak intensity N^{Li—F} of a highest intensity peak appearing in a range of 682 eV to 685 eV in an X-Ray photoelectron spectrum of a negative electrode surface of the negative electrode to a peak intensity N^{Ti} of a highest intensity peak appearing in a range of 454 eV to 460 eV in the X-Ray photoelectron spectrum of the negative electrode surface being 1.8 or more and 3 or less.

2. The nonaqueous electrolyte battery according to clause 1, wherein a ratio P^{Ni}/N^{Ti} of the peak intensity P^{Ni} to the peak intensity N^{Ti} is 1.2 or more and 1.5 or less.

3. The nonaqueous electrolyte battery according to clause 1 or 2, wherein m/z=165 negative ion count NI¹⁶⁵ and m/z=16 negative ion count NI¹⁶ in a time of flight-secondary ion mass spectrometry analysis on the negative electrode surface satisfies a relationship of 0.12<NI¹⁶⁵/NI¹⁶<0.18.

4. A battery pack comprising the nonaqueous electrolyte battery according to any one of clauses 1 to 3.

What is claimed is:

1. A nonaqueous electrolyte battery comprising:
a positive electrode containing a lithium-containing nickel-cobalt-manganese oxide;
a negative electrode containing a lithium titanium-containing oxide; and
a nonaqueous electrolyte,
a ratio P^{Li—F}/p^{Ni} of a peak intensity P^{Li—F} of a highest intensity peak appearing within a range of 682 eV to 685 eV in an X-Ray photoelectron spectrum of a positive electrode surface of the positive electrode to a peak intensity P^{Ni} of a highest intensity peak appearing within a range of 850 eV to 858 eV in the X-Ray photoelectron spectrum of the positive electrode surface being 0.6 or more and 1 or less, and
a ratio N^{Li—F}/N^{Ti} of a peak intensity N^{Li—F} of a highest intensity peak appearing within a range of 682 eV to 685 eV in an X-Ray photoelectron spectrum of a negative electrode surface of the negative electrode to a peak intensity N^{Ti} of a highest intensity peak appearing within a range of 454 eV to 460 eV in the X-Ray photoelectron spectrum of the negative electrode surface being 1.8 or more and 3 or less.

2. The nonaqueous electrolyte battery according to claim 1, wherein a ratio P^{Ni}/N^{Ti} of the peak intensity P^{Ni} to the peak intensity N^{Ti} is 1.2 or more and 1.5 or less.

3. The nonaqueous electrolyte battery according to claim 1, wherein m/z=165 negative ion count NI¹⁶⁵ and m/z=16 negative ion count NI¹⁶ in a time of flight-secondary ion mass spectrometry analysis on the negative electrode surface satisfies a relationship of 0.12<NI¹⁶⁵/NI¹⁶<0.18.

4. A battery pack comprising the nonaqueous electrolyte battery according to claim 1.
